(19) United States
(12) Patent Application Publication
(10) Pub. No.: US 2003/0055686 A1
(43) Pub. Date: Mar. 20, 2003

(54) Medical information system

(75) Inventors: Eiji Satoh, Tenri-shi (JP); Sayuri Fujiwara, Nara-shi (JP)

Correspondence Address: NIXON & VANDERHYE P.C., 8th Floor, 1100 North Glebe Rd., Arlington, VA, 22201-4714, US

(73) Assignee: SHARP KABUSHIKI KAISHA

(21) Appl. No.: 10/244,674

(22) Filed: Sep. 17, 2002

(30) Foreign Application Priority Data
Sep. 20, 2001 (JP) 2001-286885

(51) Int. Cl. G06F 17/60

(52) U.S. Cl. 705/3

(57) ABSTRACT

The present invention provides a medical information system which easily discloses medical data only to the patient corresponding to the medical data. In the present system, a display terminal 1, which is a handy viewer having reflection-type LCD screen, is provided to the patient for informed consent. Therefore, by using such a display terminal, the patient can see the data in any arbitrary places as long as he/she wants without being seen by other people, for example, in a corridor where no one else is around, or having a wall or a window behind, or in the corner of the waiting room. Thus, it is possible to sufficiently protect privacy of the patient since medical data is disclosed only to the corresponding patient, thereby providing a barrier-free medical information system.

### FIELD OF THE INVENTION

The present invention relates to a medical information system provided in a medical institution for disclosing individual medical data for each patient.

### BACKGROUND OF THE INVENTION

Conventionally, in a medical institution such as a hospital, a clinic or a pharmacy, explanations of the result of diagnosis and/or the medicines prescribed (informed consent) has not been sufficiently provided.

However, promotion of patient's right has come to public attention, as it is described that “patients have rights for drastic, fair, effective and rapid examination and treatment with respect to their complaints and for provision of the result of the examination.” in the “Announcement for promotion of patient's right” at the WHO meeting in Europe (March, 1994).

With this trend, medical institutions have been making efforts for realizing high-quality informed consent.

Meanwhile, in recent years, there have been the moves of keeping patient's medical data as electronic data.

For example, there was the notification of “regarding keeping medical records as electronic data” (Apr. 22, 1999) from Ministry of Health and Welfare in Japan.

This notification allowed medical institutions to keep the medical data including not only various image data (X-ray pictures, CT pictures, MRI images and RI images etc.) but also medical diagnosis records.

By thus keeping medical data as electronic data, it is possible to electronically copy and provide the medical records with a guarantee of identification as the original data, and further, makes it possible to establish medical institution-related system (for example, there are some hospitals having systems for viewing medical records via the Internet).

Further, a computer network system (medical data system) having functions of data arrangement, data search, data exchange etc. has been created for efficiently using medical data in medical institutions.

Further, Japanese Unexamined Patent Publication No. 171528/1997 (published Jun. 30, 1997) discloses a system for sending medical records or prescriptions inputted by doctors to the payment department or the pharmacy via the network in the hospital.

This system has a function of recognizing doctor's handwriting for making electronic data.

However, the conventional medical data system uses a fixed display (CRT etc.) for disclosing medical data to the patients and therefore, there has been a problem such that the system may allow the other people around the display screen to see the data when a patient's medical data is disclosed. Thus, in order to solve this problem, the institutions have to provide a wall around the display screen, or have to provide a separated area for viewing the medical data.

### SUMMARY OF THE INVENTION

The present invention is made in view of the foregoing conventional problems, and an object is to provide a medical information system capable of easily disclosing the medical data of a patient only to the patient corresponding to the medical data.

In order to solve the foregoing problems, the medical information system of the present invention (the present system) is a medical information system provided in a medical institution for disclosing medical data to respective patients, including a data storing device for storing the medical data; and a data display device for displaying the medical data stored in the data storing device, and the data display device is a portable mobile device.

The present system is provided in a medical institution such as a general hospital, a clinic, or a pharmacy, and stores medical information (medical data) of the patients by a data storing device and discloses the medical data to the patient corresponding to the medical data by a display device in accordance with an external instruction.

Note that, the medical data in the present system includes medical diagnosis record data, prescription data, the history of visit (hospitalization) data, data of various examinations (measurement of the height, the weight, the body fat rate or the eyesight, a urine test and a blood test) and various medical image data (X-ray pictures, CT pictures, MRI images, RI images and electrocardiogram or the like) with respect to each patient.

A noticeable feature of the present invention is that the data display device is a portable mobile device.

Namely, the patient can have the data display device in his/her hand (or by an attendant, a staff in the medical institution), and can set the display device (display screen) in an arbitrary angle. With this type of display, the patient can view the display screen in a desired posture and also it allows a disabled person can easily view the content of display.

Further, it is possible to set the angle of the display screen in a substantially horizontal. Therefore, by using this data display device for informed consent, it helps the patient to easily understand the doctor's explanation, thereby giving him/her a sense of assurance.

Further, as the data display device is a portable mobile display device, it allows the patient to view the data in any arbitrary places in the medical institution. Therefore, the patient can see the data all by himself/herself without being seen by other people.

Namely, by using such a data display device, the patient can see the data in any arbitrary places as long as he/she wants without being seen by other people, for example, in a corridor where no one else is around, or having a wall or a window behind, or in the corner of the waiting room.

Further, the present system provides the data display device so that the patient can see the medical data. Therefore, the data is not required to be printed out for the patient, and which means there is no trouble for disposing the paper (cutting etc.).

Further, it is preferable that the data display device is capable of switching the a large amount (many kinds) of data. This function allows the patient to look at all medical data regarding the patient. Therefore, the patient can easily view the all data, compared to the case of viewing the same amount of printed data.

Further, it is preferable that the display screen of the data display device is made of a reflection-type LCD (Liquid Crystal Display) panel, an EL (electro reminiscence) display, or other kinds of display suitable for a small-sized terminal, such as displays of an electricphoretic migration mode or a twist-ball mode.

Further, it is preferable that the display screen of the data display device is made of a reflection-type display panel having memory function which is capable of long hours display without running out of the buttery. Further, a reflection-type display consumes less power, and is capable of displaying an image like a picture painted on paper. Therefore, the patient more easily understands the medical data.

Further, it is preferable that the data display device includes a control section for reading out the medical data from the data storing device and displaying the data on the display screen. Further, a storing device may be provided in the data display device for temporarily storing the read medical data.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is an explanatory view showing a structure of a medical information system according to one embodiment of the present invention.

FIG. 2 is an explanatory view showing the appearance of a display terminal used for the system shown in FIG. 1.

FIG. 3 is a block diagram showing a structure of the display terminal shown in FIG. 2.

FIG. 4(a) is an explanatory view showing an example of display in the display terminal shown in FIG. 2.

FIG. 4(b) is an explanatory view showing another example of display in the display terminal shown in FIG. 2.

FIG. 5 is a flow chart showing a flow of medical data display operation in the display terminal shown in FIG. 2.

FIG. 6 is a flow chart showing a flow of medical data display operation in the display terminal shown in FIG. 2 in the case of adopting a patient's registration card made of an IC card.

FIG. 7 is a flow chart showing another flow of medical data display operation in the display terminal shown in FIG. 2 in the case of adopting a patient's registration card made of an IC card.

FIG. 8 is an explanatory view showing a structure of the medical information system in the case of adopting a patient's registration card made of an IC card having ID data and capable of inputting and storing medical data.

FIG. 9 is a flow chart showing a flow of medical data display operation in a display terminal used for the system shown in FIG. 8.

### DESCRIPTION OF THE EMBODIMENTS

The following will explain one embodiment of the present invention.

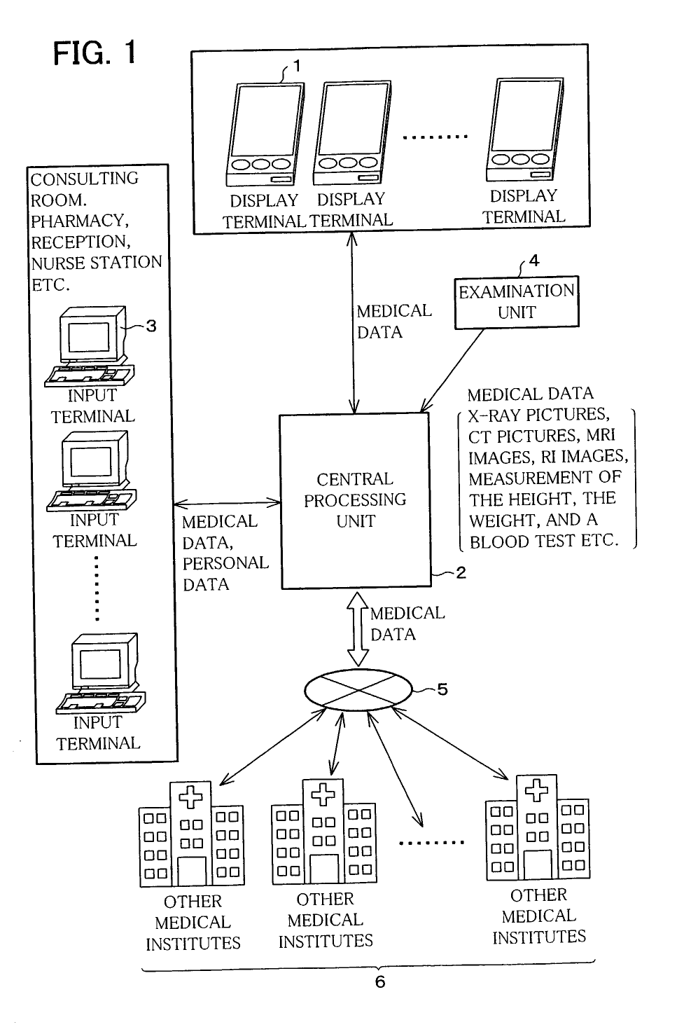

FIG. 1 is an explanatory view showing a structure of a medical information system according to the present embodiment (the present system). The present system is provided in a general hospital and used for collecting and keeping medical information (medical data) of the patients and also carrying out processing and disclosure of the medical data.

Note that, the medical data in the present system includes medical diagnosis record data, prescription data, the history of visit (hospitalization) data, data of various examinations (measurement of the height, the weight, the body fat rate or the eyesight, a urine test and a blood test) and various medical image data (X-ray pictures, CT pictures, MRI images, RI images and electrocardiogram or the like) with respect to each patient.

Further, this system has an option for the personal data of the patient, such as the data of the first visit, history of the visit, and ID data (all described later) in addition to the medical data of the patient.

As shown in FIG. 1, the present system is made up of an input terminal 3, an examination unit 4, a central processing unit 2, and a display terminal 1.

The input terminal 3 is a terminal for hospital staffs respectively provided in the reception, the consultation room, the pharmacy, the nurse station and the like.

The input terminal 3 has a display screen (display section) made of CRT or LCD and an input section made of a keyboard and a touch panel. Further, the input terminal 3 is connected to the central processing unit 2 via a wired or wireless communication line, and includes a communication section for sending and receiving data from/to the central processing unit 2.

The input terminal 3 further includes a control section for controlling the display screen, the input section and the communication section so as to carry out various processing in response to user (hospital staff)'s instruction.

Further, the input terminal 3 has a function of accepting the inputted personal and medical data (inputted by hospital staffs) of the patients who visited the hospital or are staying in the hospital and transmitting the data to the central processing unit 2 (described later).

Further, the input terminal 3 is capable of reading out the medical data and the personal data stored in the central processing unit 2 and displaying the data in the display screen. Further, the input terminal 3 also has a function of making modification (deletion, writing) with respect to the read out medical data or personal data in response to the hospital staff's instruction and re-storing the amended data in the central processing unit 2. Furthermore, the input terminal 3 has a function of creating medical data for a new patient and transmitting the data to the central processing unit 2.

The examination unit 4 examines patients, and creates the medical data with reference to the result of the examination and transmits the data to the central processing unit 2. Therefore, the examination unit 4 is made up of a medical examination device, a conversion section for converting the examination result (measurement result) to the medical data (examination data), a communication section for transmitting the examination data to the central processing unit 2.

Here, the medical examination device can be the device for taking X-ray pictures, CT pictures, MRI images, RI images and electrocardiogram, the measurement device for the height, the weight, the blood pressure, and the eyesight, and the device for a urine test and a blood test (devices measuring the values of the examinations), for example.

The display terminal (data display device) 1 is a handy (portable) wireless terminal device, and appropriately display the medical data transmitted from the central processing unit 2. In other words, the display terminal 1 has a function of a so-called viewer.

Further, the display terminal 1 has a display section made of a reflection-type LCD (Liquid Crystal Display) panel, and an operation section includes input buttons and a touch panel. Note that, the structure details of the display terminal 1 will be described later.

The central processing device (a device for storing and accepting data) 2 is the main part of the system which controls all of the operation of the present system. Namely, the central processing unit 2 stores the medical data of each patient which is transmitted from the input terminal 3 and the examination unit 4, and processes or calculates the medical data as required (in response to the instruction transmitted from outside of the central processing unit 2).

Further, the central processing unit 2 also has a function of transmitting (sending) the medical data to display terminal 1 or the input terminal 3 in response to the instruction by these terminals 1 and 3.

Furthermore, the central processing unit 2 is capable of sending and receiving the medical data to/from other medical institutions 6 outside of the hospital (the systems of the other medical institutions 6) via the Internet 5.

In order to realize the function above, the central processing unit 2 includes a storage section for storing (keeping) the medical data, a computing section for carrying out a program or data processing, and a communication section for carrying out the sending and receiving of the data to/from the display terminal 1, the input terminal 3, the examination unit 4 and the Internet 5 (the other medical institution).

Note that, the input terminal 3 of the present system is capable of external communication (the communication using the Internet 5) via the central processing unit 2. Therefore, it is possible to read out the medical data from the other medical institutions 6 by the input terminal 3.

The following will explain the operation flow in the present system.

When a patient visits the hospital and finishes the required procedure at the reception, information of the visit (data of the visit) and information for specifying the visited patient (information of ID number for specifying the patient which is determined in the hospital: ID data) are inputted to the input terminal 3 provided in the reception by a hospital staff.

Then, the input terminal 3 transmits the inputted data of the visit and ID data to the central processing unit 2. The central processing unit 2 accepts the data of the visit and ID data and renews the data of visit history of the patient based on the inputted data.

Note that, in the case of new patient, information of the health insurance, or the content of questioner for the first visit (first visit data) is inputted to the input terminal 3 by a hospital staff. Then, the central processing unit 2 creates the medical data and the data of visit and ID data of the patient based on the first visit data.

Further, a receptionist inputs the ID data of the patient to one of the display terminal 1 provided in the hospital, and gives the terminals to the patient.

Thereafter, in the diagnosis of the patient, the doctor or a nurse make the input terminal 3 provided in the consultation room to read out all data of the patient related to the diagnosis (or the major medical data) from the central processing unit 2 and display the data on the display screen.

Then, the doctor carries out the diagnosis with reference to the displayed data of the patient. After the diagnosis, the input terminal 3 accepts inputs of new medical data such as the diagnosis record or the prescription which is made in accordance with the result of diagnosis, then transmits the inputted new data to the central processing unit 2. The central processing unit 2 accepts the data transmitted from the input terminal 3, and renews the saved medical data based on the new data.

Further, the doctor examines the patient with the examination unit 4 if required. The examination unit 4 obtains the various medical image data (X-ray pictures, CT pictures, MRI images, RI images and electrocardiogram or the like, and carries out measurement of the height, the weight, the blood pressure or the eyesight, and a urine test or a blood test. Then, the examination unit 4 converts the result of examination to the examination data and transmits the data to the central processing unit 2.

The central processing unit 2 accepts the examination data and renews the saved medical data based on the data. Further, here, the input terminal 3 also accepts the additional medical data made by the doctor according to the examination data (the diagnosis record or the prescription), and transmits the data to the central processing unit 2.

Further, the central processing unit 2 has a function for selecting the prescription data from the inputted data by the doctor via the input terminal 3, and transmitting the proscription data to the input terminal 3 provided in the pharmacy.

Then, the input terminal 3 in the pharmacy displays the transmitted prescription data in the display screen in response to the pharmacy staff (pharmacist)'s instruction.

Further, the present system is capable of displaying the medical data of each patient saved in the central processing unit 2 with the display terminal 1 which has been given to the patient. This enables the doctor to use the terminal 1 given to the patient as well as the input terminal 3 when he/she tells the patient about the result of diagnosis and the result of examinations (when he/she carries out informed consent).

Namely, the patient operates the display terminal 1 so as to display the medical data of medical images, diagnosis records, and prescriptions, which are saved in the central processing unit 2 in the display screen of the display terminal 1 in accordance with the doctor's instruction. This enables the doctor to explain the medical data thus displayed on the display screen of the display terminal 1.

After the explanation (diagnosis) by the doctor, the patient takes out the display terminal 1 with him/her so that he/she can review the medical data so as to reconfirm the result of diagnosis or the effect and side effect of the prescribed medicines till he/she leaves the hospital. When the patient receives the prescribed medicines in the pharmacy and finishes the payment, the display terminal 1 is given back to the hospital at the reception.

Note that, in the case where the patient needs treatment of drip infusion or an injection after the diagnosis by the doctor, the doctor makes the instruction for the treatment and inputs the instruction to the input terminal 3 as the medical data. Then, the display terminal 1 displays the instruction of the treatment in response to the doctor (nurse)'s instruction so that the patient confirms the details of the treatment with the display terminal 1 before he/she leaves for the room for treatment.

When the patient enters the room for treatment, the input terminal 3 provided in the room displays the data of the details of treatment in response to the instruction by the staff who carries out the treatment. Then, the staff carries out the treatment based on the data of the details of treatment.

As described, the present system provides the display terminal 1, which is a handy-type viewer having a reflection-type LCD display screen, so as to carry out informed consent.

With this type of display screen, the patient can view the display screen in a desired posture. This allows a disabled person to easily view the content of display.

Further, as the reflection-type LCD allows a user to view the screen even in a horizontal position, it helps the patient to easily understand the doctor's explanation, thereby giving him/her a sense of assurance.

Further, the doctor can make sure the condition of the patient shown in medical images such as X-ray picture, by reviewing the image with the patient.

Further, as the display terminal 1 is a handy-type display device, the patient can look at the medical data even after the diagnosis till he/she leaves the hospital. This provides the patient some time to consider taking the treatment or the medicines before the treatment or provision of the medicines. (it is possible to confirm these details anytime on the way to the treatment room or the pharmacy.) Besides, it can prevent the hospital staff from carrying out a wrong treatment or giving a wrong medicines.

Further, when wrong information is inputted due to operating mistake by a hospital staff, it can be found more easily before the treatment.

As described, providing the display terminal 1 makes the patient easily confirm the details of treatment or medicines, thereby giving him/her a sense of assurance.

Further, the patient can view the medical data on his/her own without being seen by other people, as the display terminal 1 is a handy-type display device. Namely, providing the handy-type display device as with the display terminal 1 allows the patient to select the place to view the data. For example, the patient can see the data as long as he/she wants without being seen by other people in a corridor where no one else is around, or having a wall or a window behind, or in the corner of the waiting room.

Further, the present system provides the display terminal 1 so that the patient can see the medical data. Therefore, the data is not required to be printed out for the patient, and which means there is no trouble for disposing the paper (cutting etc.). Further, the patient can look at a large amount of data by switching the various kinds of data in the display terminal 1. This allows the patient to easily view the data, compared to the case of viewing the same amount of printed data.

The following will explain the display terminal 1 which has a characteristic structure of the present system.

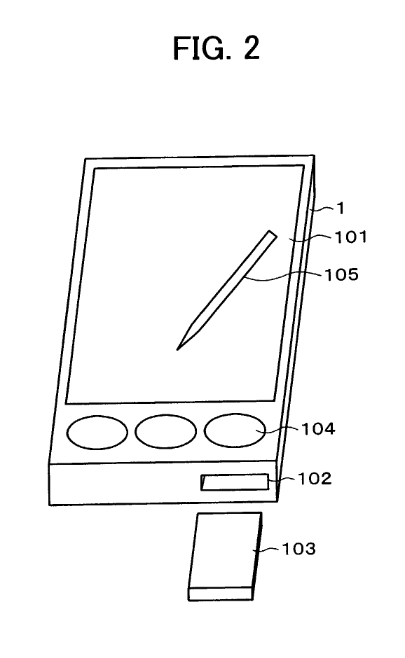

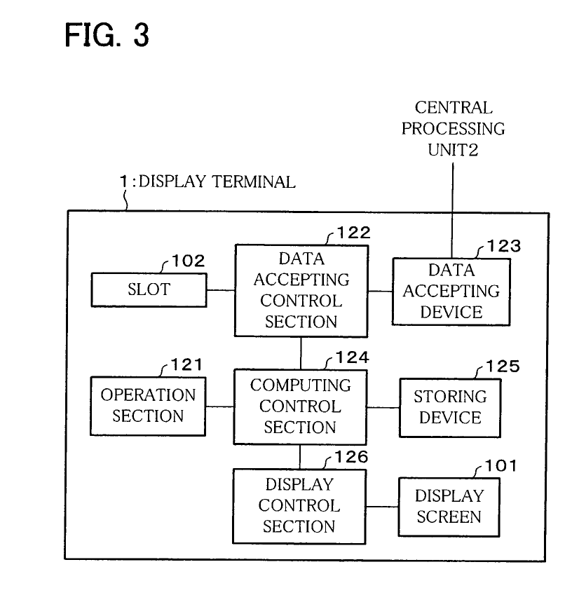

FIG. 2 is an explanatory view showing the appearance of a display terminal 1, and FIG. 3 is a block diagram showing a structure of the display terminal 1.

As shown in FIG. 2, the display terminal 1 includes a display screen 101, a slot 102, and input buttons 104.

The display screen 101 is made of a reflection-type LCD (Liquid Crystal Display) having memory function.

Further, the display screen 101 has a touch tablet (touch panel: input section) on its surface. This enables a user (patient etc.) to give an instruction to the display terminal 1 (operate the display terminal 1) for switching the display of the display screen 101 or scrolling the display, by touching the screen with a finger or a touch-pen (input section) 105.

The input buttons (input section) 104 is an operation section for giving an instruction to the display terminal 1 as with the touch tablet above.

Namely, the display terminal 1 accepts the user's instruction via the touch tablet and the input buttons 104.

The slot 102 is a loading slot for inserting a patient's registration card 103. Here, the patient's registration card 103 includes a simple circuit only having a conductive section therein at a predetermined portion. The slot 102 is capable of judging whether or not the patient's registration card is inserted therein by sensing the conductive section of the patient's registration card 103.

Further, the slot 102 transmits a signal showing the judgment result (presence or absence of the patient's registration card 103) to a data accepting control section 122 (described later).

Further, as shown in FIG. 3, the display terminal includes an operation section 121, a data accepting control section 122, a data accepting device 123, a computing control section 124, a storing device 125 and a display control section 126.

The operation section (input section) 121 represents the touch tablet and the input buttons 104. The data accepting device 123 accepts data sent from the central processing unit 2.

The data accepting control section (control section) 122 controls the data accepting device 123 so as to accept data, and also transmits the accepted data to the computing control section 124. Further, the data accepting control section 122 has a function of transmitting the presence or the absence of the patient's registration card 103 in the slot 102 to the computing control section 124.

The display control section (control section) 126 is a driving circuit of the display screen 101 which controls the display screen 101 so as to display the data (medical data) transmitted from the computing control section 124. The storing device 125 stores the medical data inputted from the central processing unit 2 via the data accepting device 123.

The computing control section (control section) 124 made of CPU (Central Processing Unit) or the like is main part of the display terminal 1 which controls all operations of the display terminal 1. Namely, the computing control section 124 controls each section of the display terminal 1 so as to carry out processing or computing in response to the user's instruction which is inputted to the operation section 121.

For example, the computing control section 124 controls the data accepting control section 122 so as to accept data, and controls the storing device 125 so as to store the accepted data. Further, the computing control section 124 controls the display control section 126 so as to display the stored (or accepted) data in the display screen 101.

Further, it is noticeable that the computing control section 124 determines whether or not the display terminal 1 is ready to operate (ready to use) in accordance with information of the presence or absence of the patient's registration card 103 in the slot 102, which is transmitted from the data accepting control section 122.

Namely, when the patient's registration card 103 is inserted in the slot 102, the computing control section 124 has a function of making the data accepting device 123 to be ready to accept data, and functions of storing the accepted medical data in the storing device 125 or displaying the medical data in the display screen 101, in accordance with the user's instruction.

On the other hand, when the patient's registration card 103 is not inserted in the slot 102, the computing control section 124 controls the data accepting device 123 so as not to accept data, and also stops the data memory function of the storing device 125 and the data display function of the display screen 101.

Further, when the computing control section 124 judges that the patient's registration card 103 is removed from the slot 102, the computing control section 124 deletes all medical data stored in the storing device 125, and also stops the display of the display screen 101.

The following will explain medical data display operation by the display terminal 1.

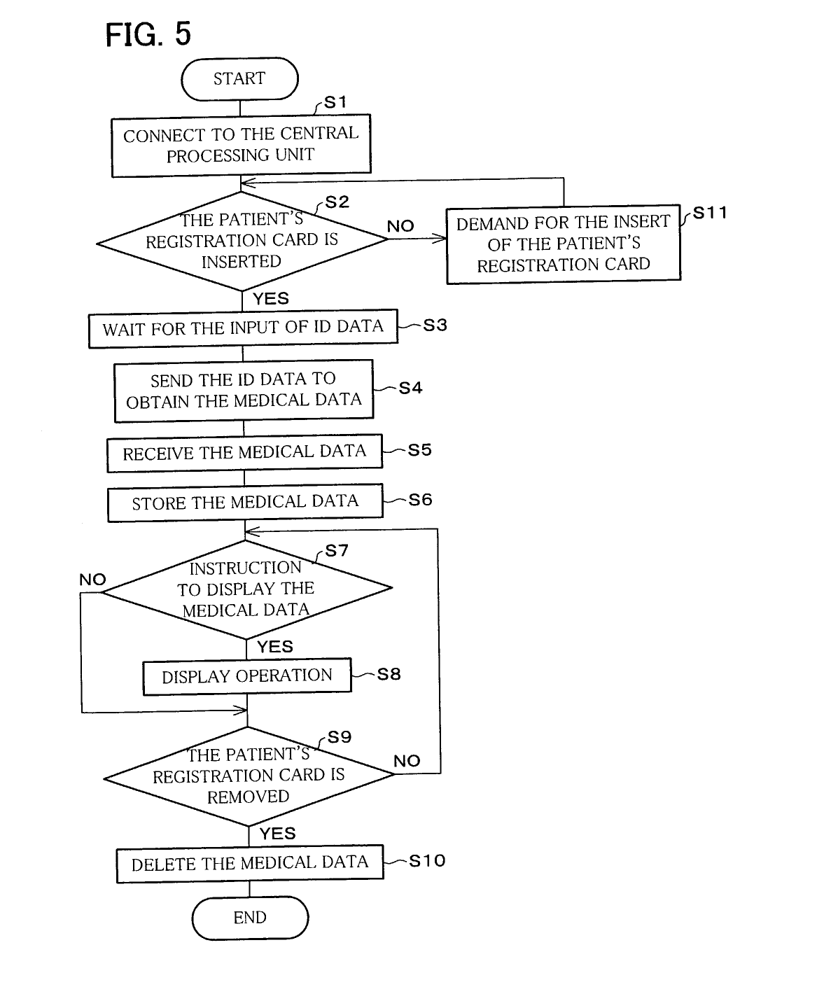

FIG. 5 is a flow chart showing a flow of medical data display operation in the display terminal 1. As shown in the figure, when the power of the display terminal 1 is turned on and the communication with the central processing unit 2 becomes ready (S1), the computing control section 124 judges whether or not the patient's registration card 103 is properly inserted in the slot 102 (S2). Then, when the computing control section 124 judges the patient's registration card 103 is not properly inserted in the slot 102, it controls the display control section 126 so as to display an image for demanding the insertion of the patient's registration card 103 in the display screen 101 (S11), then goes back to the process of S2.

On the other hand, when the computing control section 124 judges the patient's registration card 103 is properly inserted in the slot 102, it makes the data accepting device 123 to be ready for data communication, and waits for the instruction which will be inputted through the operation section 121 (S3). Then, when the information for specifying the patient (ID data) is inputted by a user (hospital staff: a doctor or a nurse), the computing control section 124 sends the ID data to the central processing unit 2 so as to obtain the medical data of a patient corresponding to the ID data (S4).

Thereafter, when the data accepting device 123 receives the medical data from the central processing unit 2 (S5), the computing control section 124 stores the medical data in the storing device 125.

Then, the computing control section 124 waits for the user (a hospital staff or the patient)'s instruction for displaying the data (S7). When the instruction for displaying the data is made, the computing control section 124 controls the data accepting control section 122 so as to display the medical data in accordance with the instruction (S8).

When the computing control section 124 judges that the patient's registration card 103 is removed from the slot 102, it stops the display of the display screen 101 and deletes all medical data stored in the storing device 125 (S10) as the closure of the operation.

Note that, the foregoing processes S1 through S6 and S11 in the display terminal 1 are normally carried out in accordance with the instruction by a hospital staff (mainly by a staff in the reception), since the patient's registration card 103 is given to the reception of the hospital upon arrival of the patient.

Namely, a hospital staff at the reception inputs the data of visit and the ID data to the input terminal 3, then arbitrarily selects one of the display terminals 1 and inserts the patient's registration card 103 to the slot 102 of the display terminal 1. Further, the hospital staff inputs the ID data of the patient to the display screen 101 so as to store the medical data of the patient in the display terminal 1. Then, the hospital staff gives the display terminal 1 to the patient.

Further, the processes from S7 to the end are carried out in accordance with the instruction of the patient or a hospital staff. Then, the patient's registration card 103 is removed from the display terminal 1 by the patient or a hospital staff when the patient leaves the hospital, and is taken away with the patient. Meanwhile, the display terminal 1 is given back to the hospital after the patient's registration card 103 is taken out.

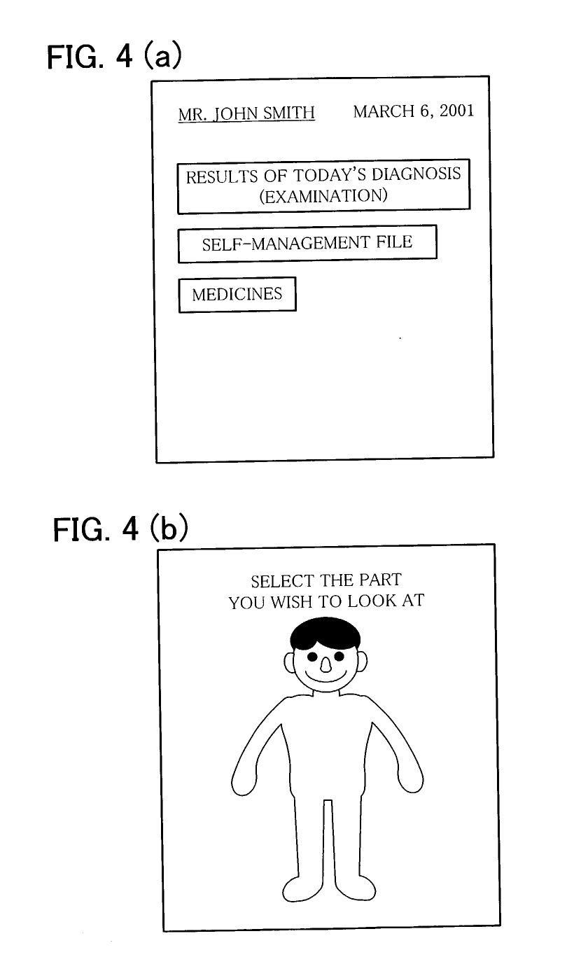

Here, the following will explain a display example of the display terminal 1 (the display screen 101). FIG. 4(a) and 4(b) are explanatory views showing examples of the display.

When the patient's registration card 103 is inserted in the slot 2 and the ID data is inputted, selections (buttons on the screen) of “the result of today's diagnosis (examination)”, “self-management file” and “medicines” are displayed on the display screen 101 with the patient's name and the date as shown in FIG. 4.

When “the result of today's diagnosis (examination)” is selected through the input buttons 104 or the touch tablet (touch panel), the result of diagnosis or examinations of the day, and medical images taken in the day are displayed in the display screen 101.

Here, when the result of diagnosis or examinations is displayed, display terminal 1 has two types of display:

the display for making explanations to the patient by the doctor (for example, explanations of the symptom and how to cure);

the display of proper records of the diagnosis or the examinations.

Further, the patient or the hospital staff can select the form of the display.

Further, when select “self management file” in the display shown in FIG. 4(a), the display screen 101 displays the histories of the result of diagnoses and examinations in other hospitals. The histories are shown for each hospital or each part of the body.

Here, when the histories are shown for each part of the body, a sort of “body map” is displayed as shown in FIG. 4. Further, when a part of the body is selected on the body map, the medical data regarding the selected part is displayed. For example, when the user selects an arm, the history of all results of diagnoses and examinations (name of the hospital, date, details, if there are any medical images, cures, medicines etc.) regarding the arm is displayed. If there are any medical images, the user can view the images at this time.

Further, when the user selects “medicines” on the display of FIG. 4(a), the terminal displays all information about medicines such as the medicines currently used, the medicines used in the past, if there have been any troubles due to side effect of the medicines etc., and also the explanation of the medicines currently used.

As described, the display terminal 1 of the present system includes the slot 2 for inserting the patient's registration card 103, and the slot 2 detects whether or not the patient's registration card is inserted therein. That is, only when the slot 2 detects that the patient's registration card is inserted therein, the computing control section 124 displays the medical data.

Namely, the slot 2 and the patient's registration card 103 perform a switch for the display of the display terminal 1. More specifically, the patient can obtain the display by inserting his/her patient's registration card 103 in the slot 2. Further, the patient disables the display of the display terminal 1 and deletes all medical data by removing the patient's registration card 103 from the slot 2

Here, the patient's registration card 103 is always taken away with the patent when the patient leaves the hospital. Accordingly, after referring to the medical data, the patient can confirm the end of the medical data display with an operation by himself/herself (taking out (away) the patient's registration card 103).

Therefore, the patient feels secure about privacy protection, as there is no possibility that the medical data is still left in the display terminal 1 which has been used once the patient takes out the patient's registration card.

Note that, in the present embodiment, the slot 102 includes a simple circuit only having a conductive section therein at a predetermined portion, and the slot 102 is capable of judging whether or not the patient's registration card is inserted therein by sensing the conductive section of the patient's registration card 103. However, the present invention is not limited to it, and may be arranged such that an optical sensor is provided for sensing whether or not the patient's registration card is inserted. In this case, the circuit is not necessary.

Further, a switching function may be provided in the slot 102 so as to automatically turn on/off the power of the display screen 101 by inserting and removing the patient's registration card 103.

However, it is preferable that the patient's registration card 103 has a predetermined shape or a component so as to be distinct from other cards. This enables the slot 102 to detect that the patient's registration card is inserted therein by sensing the shape or the component. Namely, the slot 102 detects that the patient's registration card is not inserted therein when it does not sense the shape or the component.

Further, the patient's registration card 103 may be made of (ID card) having ID data for specifying the patient.

In this case, the slot 102 of the display terminal 1 reads out the ID data stored in the patient's registration card 103 inserted therein, and transmits the data to the computing control section 124. Then, the computing control section 124 checks the ID data inputted by a hospital staff with the ID data transmitted from the slot 102. When confirming a match of the two ID data, the computing control section 124 activates the display terminal 1.

Further, when the patient removes the patient's registration card 103 from the slot 102 after displaying the medical data in the display terminal 1, the computing control section 124 deletes all data stored in the storing device 125 and deactivates the display terminal 1 (stops the data accepting function of the data accepting device 123, the data memory function of the storing device 125 and the data displaying function of the display screen 101).

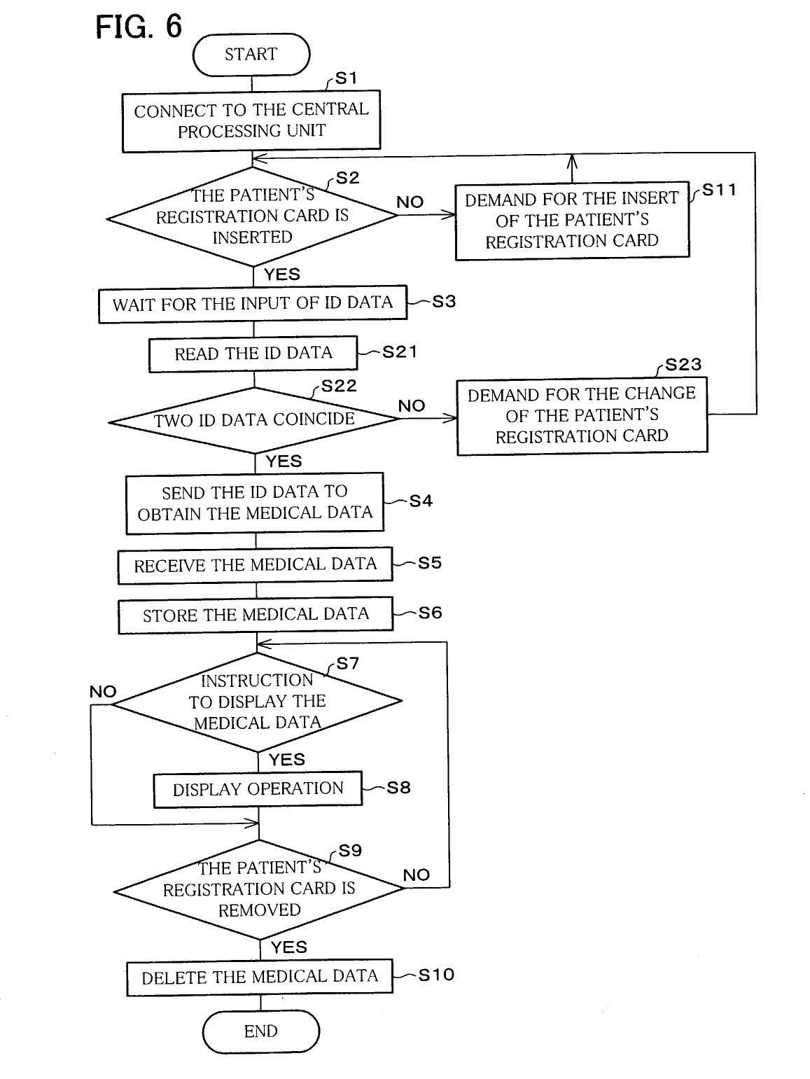

FIG. 6 is a flow chart showing a flow of medical data display operation in the display terminal 1 in the case of adopting the patient's registration card made of an IC card.

As shown in the figure, the operation is the same as that shown in FIG. 5 except for the steps S21 through S23 provided between S1 through S4.

Namely, as with the operation of FIG. 5, in the operation shown in FIG. 6, when the communication between the display terminal 1 and the central processing unit 2 becomes ready, the computing control section 124 judges whether or not the patient's registration card 103 is properly inserted in the slot 102, and accepts the input of ID data of the patient (S1 through S3, S11).

Thereafter, the computing control section 124 controls the slot 102 via the data accepting control section 122 so as to read out the ID data stored in the patient's registration card 103 which is inserted in the slot 102 (S21). Further, the computing control section 124 checks the ID data inputted at the step of S3 with the ID data read out at the step of S21 (S22).

When the computing control section 124 judges that the two ID data do not coincide with each other, it controls the display control section 126 so as to display an image for demanding the change of the patient's registration card 103 in the display screen 101 (S23), then goes back to the process of S2.

On the other hand, when the computing control section 124 judges that the two ID data coincide with each other, it sends the ID data to the central processing unit 2 so as to obtain the medical data of a patient corresponding to the ID data (S4), as with the operation shown in FIG. 5. Note that, the rest of the steps are the same as that in the operation shown in FIG. 5.

As described, with the foregoing operation, the medical data display is carried out in the display terminal 1 only when confirming the two ID data (the inputted ID data and the ID data stored in the patient's registration card 103) coincide with each other. Therefore, it is possible to prevent disclosure of wrong medical data (the medical data of a wrong patient) to the patient by error operation (inputting a wrong ID card) etc.

Note that, with the foregoing operation, when judging that the two ID data do not coincide with each other at the step of S22, the display for demanding the change of the patient's registration card 103 is carried out with respect to the user (hospital staff) at the step of S23, then the operation goes back to S2.

However, the present invention is not limited to it, and may be arranged such that the display for demanding another input of the ID data is carried out instead of the display for demanding the change of the patient's registration card 103, and then the operation goes back to S3.

Further, when thus using the patient's registration card 103 made of an IC card, it is possible to realize an operation for sending the medical data to the display terminal 1 without the input of the ID data by a hospital staff.

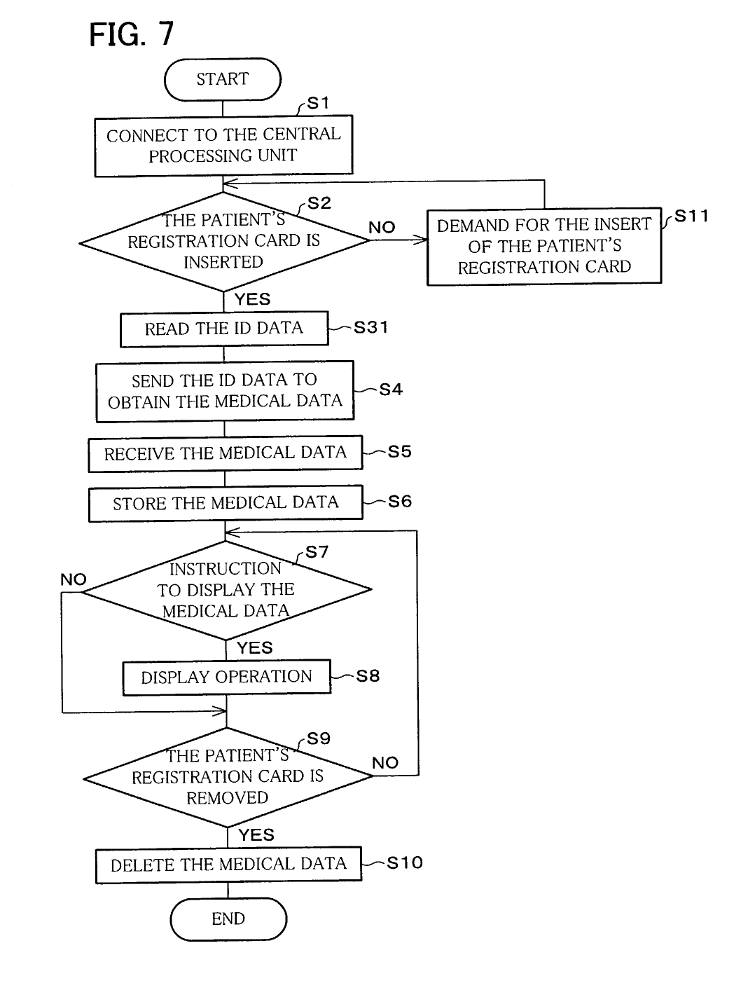

FIG. 7 is a flow chart showing the flow of this operation.

As shown in the figure, this operation is the same as that shown in FIG. 5 except for the step S31 provided instead of the step S3.

Namely, as with the operation of FIG. 5, in the operation shown in FIG. 7, when the communication between the display terminal 1 and the central processing unit 2 becomes ready, the computing control section 124 judges whether or not the patient's registration card 103 is properly inserted in the slot 102 (S1 through S2, S11).

Thereafter, the computing control section 124 controls the slot 102 via the data accepting control section 122 so as to read out the ID data stored in the patient's registration card 103 which is inserted in the slot 102 (S31). Further, the computing control section 124 sends the ID data to the central processing unit 2 so as to obtain the medical data of a patient corresponding to the ID data (S4). Note that, the rest of the steps are the same as that in the operation shown in FIG. 5.

As described, in the operation shown in FIG. 7, the medical data is provided according to the ID data, which is read out from the patient's registration card 103 by the slot 102. Therefore, it is possible to prevent disclosure of wrong medical data (the medical data of a wrong patient) to the patient by error operation (inputting a wrong ID data) etc. Further, since it is not necessary to manually input the ID data, the display operation can be carried out more quickly and easily.

Note that, in the operations of FIG. 6 and FIG. 7, the processes S1 through S6, S11, S21 through S23, and S31 in the display terminal 1 are normally carried out in accordance with the instruction by a hospital staff (mainly by a staff in the reception), as with the operation of FIG. 5.

Further, the processes from S7 to the end are carried out in accordance with the instruction of the patient or a hospital staff, as with the operation of FIG. 5. Then, the patient's registration card 103 is removed from the display terminal 1 by the patient or a hospital staff when the patient leaves the hospital, and is taken away with the patient. Meanwhile, the display terminal 1 is given back to the hospital after the patient's registration card 103 is taken out.

Note that, the foregoing operation shown in FIGS. 6 and 7 uses the patient's registration card 103 made of an IC card and having the ID data. However, it is not necessarily have to be the patient's registration card 103 made of an IC card, and other kinds of card may be used as long as it is capable of storing the ID data.

For example, a magnetic card having magnetically recorded ID data may be used as the patient's registration card 103. In this case, a magnetic reading device has to be provided in the slot 102. Further, the patient's registration card 103 may include bar-code corresponding to the ID data a bar-code reading device may be provided in the slot 102 so as to read bar-code (bar code information) corresponding to the ID data, which is included (attached, impressed, or printed) in the patient's registration card 103.

Further, the patient's registration card 103 may be made of an IC card capable of inputting and recording the medical data as well as recording the ID data.

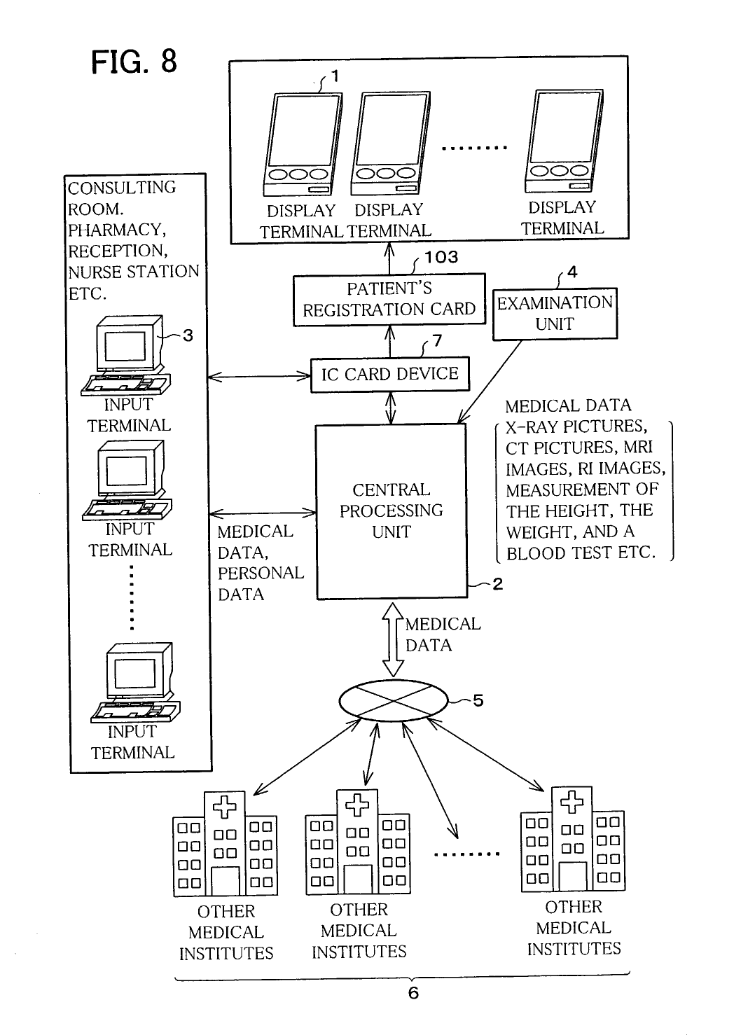

FIG. 8 is an explanatory view showing a structure of the medical information system using the patient's registration card 103 made of such a recording medium. As shown in the figure, this system has the same structure as that shown in FIG. 1 except for an IC card device 7 (and the patient's registration card 103).

The IC card device (media recording device) 7 is a device for reading and recording the information included in an IC card, and is connected to the central processing unit 2. The IC card device 7 includes a slot (not shown) for inserting the patient's registration card 103.

The IC card device 7 reads the ID data from the patient's registration card 103 inserted in the slot, and send the read data to the central processing unit 2 so as to obtain the medical data of the patient corresponding to the ID data.

Then, after obtaining the medical data from the central processing unit 2, the IC card device 7 records (writes) the medical data to the patient's registration card 103.

Further, the medical data recorded on the patient's registration card 103 can be viewed (reproduced) with a display screen (not shown) of the IC card device 7.

Further, when using such a patient's registration card 103, the data accepting control section 122, the data accepting device 123 and the storing device 125 are not provided in the display terminal 1.

Further, the slot 102 of the display terminals has to be capable of reading the medical data from the patient's registration card 103 inserted therein. Namely, the slot 102 reads the medical data from the patient's registration card 103 inserted therein and transmits the data to the computing control section 124. Then, the computing control section 124 controls the display control section 126 so as to display the medical data transmitted from the slot 102 in the display screen 101.

Further, when using such a patient's registration card 103, the display terminal 1 works only when having the patient's registration card 103 (data source) therein, as the storing device 125 is not provided.

Further, with this structure, when the patient's registration card 103 is removed from the slot 102, the computing control section 124 deactivates the display terminal 1 (stops the data displaying function of the display screen 101).

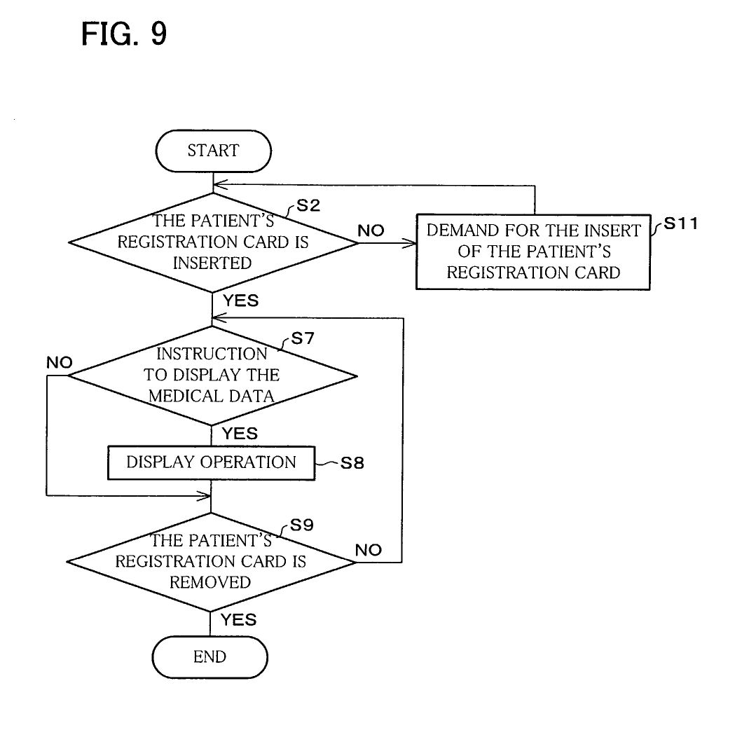

FIG. 9 is a flow chart showing the display operation in the display terminal 1 when using the foregoing patient's registration card 103

As shown in the figure, the steps S1, S3 through S6 and S10 of the operation shown in FIG. 5 are omitted in this operation.

Namely, at the time of this operation, the patient's registration card 103 has the medical data record which is supplied from the IC card 7. The computing control section 124 judges whether or not the patient's registration card 103 is properly inserted in the slot 2 (S2).

Then, when the computing control section 124 judges the patient's registration card 103 is not properly inserted in the slot 102, it controls the display control section 126 so as to display an image for demanding the insertion of the patient's registration card 103 in the display screen 101 (S11), then goes back to the process of S2.

On the other hand, when the computing control section 124 judges the patient's registration card 103 is properly inserted in the slot 102, it waits for the user (a hospital staff or the patient)'s instruction for displaying the data (S7). When the instruction for displaying the data is made, the computing control section 124 controls the slot 102 so as to read the required medical data from the patient's registration card 103, and controls the data accepting control section 122 so as to display the required medical data (S8).

When the computing control section 124 judges that the patient's registration card 103 is removed from the slot 102, it stops the display of the display screen 101 as the closure of the operation.

As described, in the operation shown in FIG. 9, the medical data is displayed after being read from the patient's registration card 103 by the slot 102. Therefore, it is possible to prevent disclosure of wrong medical data (the medical data of a wrong patient) to the patient by error operation.

Further, the IC card device 7 records the medical data to the patient's registration card 103 based on the ID data stored in the patient's registration card 103. Therefore, it is possible to prevent recording of wrong medical data (the medical data of a wrong patient) to the patient's registration card 103. Further, since it is not necessary to manually input the ID data, the recording operation can be carried out more quickly and easily.

Further, the patient can delete the medical data from the display terminal 1 by his/her own operation (removing the patient's registration card 103). Therefore, the patient feels secure about privacy protection.

Further, when using the patient's registration card 103 thus described, the patient can carry the medical data with the patient's registration card 103.

Therefore, the patient can display the medical data in the display terminal 1 without communicating with the central processing unit 2.

Further, the patient can view the medical data anywhere (for example, at home, or at the working place) and anytime he/she wants.

Note that, in the foregoing operation, the IC card device 7 reads out the medical data from the patient's registration card 103, and records the data to the patient's registration card 103 based on the ID data.

However, the present invention is not limited to it, and may be arranged such that the ID card device 7 has an input device for the ID data and the user (the patient or a hospital staff) inputs the ID data with this device after inserting the patient's registration card 103 to the IC card device 7.

In this case, the IC card device 7 checks the ID data inputted by the user with the ID data read from the patient's registration card 103. When confirming that the two ID data coincide with each other, the IC card device 7 records the medical data to the patient's registration card 103.

Further, in the operations of FIG. 9, the processes S2 and S11 are carried out in accordance with the instruction by a hospital staff. Further, the processes from S7 to the end are carried out in accordance with the instruction by the patient or a hospital staff.

With the foregoing case, The IC card device 7 reads the ID data from the patient's registration card 103 inserted in the slot, and send the read data to the central processing unit 2 so as to obtain the medical data of the patient corresponding to the ID data. Then the IC card device 7 records the obtained medical data to the patient's registration card 103.

However, the present invention is not limited to it, and the recording operation in the IC card 7 may be controlled by the input terminal 3. Namely, the IC card device 7 obtains the medical data of the patient in response to the input to the input terminal 3 (transmission of the ID data) by a hospital staff. Then the IC card device 7 records the obtained medical data to the patient's registration card 103

Further, the medical data from the central processing unit 2 may be sent to the input terminal 3 first, then is sent to the IC card device 7 so that the IC card device 7 records the medical data to the patient's registration card 103. In this case, the IC card device 7 is indirectly connected to the central processing unit 2 via the input terminal 3.

Further, when using a patient's registration card 103 capable of storing the medical data, the data accepting control section 122, the data accepting device 123 and the storing device 125 are not provided in the display terminal 1. However, the present invention is not limited to it, and may be arranged such that the computing control section 124 stops the use (functions) of the data accepting control section 122, the data accepting device 123 and the storing device 125 of the display terminal 1. With this function of the computing control section 124, it is possible to use the structure for the operation of FIG. 9.

Further, in the present embodiment, the display terminal 1 is a handy (portable) wireless terminal device. In this case, the device may adopt electromagnetic communication using Bluetooth or the like.

Further, a wired display terminal 1 (data transfer by using a data line) can also be used as well as the wireless device. In this case, when the display terminal 1 displays the medical data, it is preferable to mount the display terminal 1 to a cradle, for example.

Further, in the present embodiment, the display terminal 1 is given to the patient upon his/her arrival. However, the present invention is not limited to it, and the display terminal 1 may be given to the patient at the beginning or end of the diagnosis. Further, it may be given when the patient want it.

Further, the display terminal 1 may have a function for obtaining medical data of other medical institutions via the central processing unit 2 or the Internet. Further, the display terminal 1 may have a function for modifying the medical data stored in the central processing unit 2.

Further, in the present embodiment, the display terminal 1 has a display screen made of a reflection-type LCD (Liquid Crystal Display) panel. However, the display screen of the display terminal 1 may be made of an EL (electro reminiscence) display, or other kinds of display suitable for a small-sized terminal, such as displays of the electricphoretic migration mode or the twist-ball mode.

Further, it is preferable that the display screen of the display terminal 1 is made of a reflection-type display panel having memory function which is capable of long hours display without running out of the buttery. Further, a reflection-type display consumes less power, and is capable of displaying an image like a picture painted on paper. Therefore, the patient more easily understands the medical data.

Note that, the present system is capable of displaying all medical data in the past of each patient regarding treatments (diagnoses) and results of examinations on the display screen of the display terminal 1. This medical data also includes the data from the other medical institutions, which is obtained via the Internet. Further, the present system is capable of displaying the list of medicines currently taken prescribed in the hospital having the present system and prescribed in the other medical institutions. The patient can also view the effects and side effects of these medicines in the display.

Further, in the present embodiment, the display terminal 1 is used for displaying medical data. However, it may also be capable of modifying the medical data. In this case, it is preferable that a strict password is required to modify the data so as not to allow a person other than a hospital staff to make modification of the medical data with the display terminal 1. With this function, the input terminal 3 is not required in the consultation room since the doctor can input the result of the diagnoses etc. to the display terminal 1.

Further, in the present embodiment, the display terminal 1 is a handy portable device. However, the present invention is not limited to it, and the display terminal 1 may be any type of display device as long as it is capable of displaying the medical data.

For example, the display terminal 1 may be made of a mounted type display device. Further, a printer may be provided with the display terminal 1 so as to print the display result. The operations of FIGS. 5 through 7 and FIG. 9 may be carried out in this structure as long as the slot 102 and the computing control section 124 are provided.

Further, in the present embodiment, the patient's registration card 103 is inserted to the slot 102; however, any personal belongings may be used instead of the patient's registration card 103, such as a driver's license or a credit card.

Further, in the present embodiment, at the time of the diagnosis, the input terminal 3 in the consulting room displays the medical data stored in the central processing unit 2. Here, in the present system, the central processing unit 2 may be capable of reading out the patient's medical data of other medical institutions 6 (external medical data) via the Internet by a doctor's instruction.

In this case, it is preferable that the central processing unit 2 has a function of respectively arranging the internal medical data and the external medical data before transmitting them to the input terminal 3 by the doctor's instruction.

In this case, the central processing unit 2 arranges the medical data of the patient such as the list of medicines prescribed in various hospitals and transmits the arranged data to the input terminal. The medical data is arranged depending on the hospital, the time of prescription, and the type of medicines, for example. This enables the input terminal 3 to display the prescription list to the doctor or the patient, which consists of plural kinds of medical data and has been arranged. Also, the doctor carries out the diagnosis with reference to the displayed information, and inputs new information of the patient such as a diagnosis record or a prescription.

This structure provides a large amount of information so that the doctor easily understands the condition of the patient. Therefore, it allows the doctor to carry out more precise diagnosis.

Further, the medical data may include data of patient's photograph or the apparent characteristics so as to display the data with the medical data in the input terminal 3 or the display terminal 1. By providing this data, it is possible to prevent mix-up of the patients by a hospital staff. Further, it is preferable that the personal data of the patient is displayed when displaying the medical data in the input terminal 3 or the display terminal 1.

Further, in the present embodiment, the central processing unit 2 transmits the prescription data to the input terminal 3 provided in the pharmacy, by selecting the data from the medical data inputted by the doctor with the input terminal 3 in the consulting room.

However, the present invention is not limited to it, and the central processing unit 2 may transmit the prescription data to the input terminal 3 in the pharmacy in response to the instruction (inputted instruction by a pharmacy staff) from the input terminal 3 in the pharmacy.

Further, in the present embodiment, the present system is provided in a general hospital. However, the present invention is not limited to it, and the present system may suitably be adopted for a smaller hospital, a clinic, or a pharmacy which deals with prescriptions.

Further, in the present embodiment, the central processing unit 2 and the input terminal 3 are respectively provided in the present system. However, the present invention is not limited to it, and the input terminal 3 may include the function of the central processing unit 2 instead of separately providing the central processing unit 2.

Further, in the present embodiment, the present system is provided in a medical institution so as to allow the patients to view their medical data. However, the present invention is not limited to it, and the present system may be provided in a facility which keeps personal information with respect to plural individuals so as to allow the specific visitors (For example, the patient corresponding to the information) to view the personal information.

Accordingly, the present system may be provided in any types of facility which keeps personal information with respect to plural individuals. In this case, it is possible to use a personal card regarding the facility, or an official ID (a driver's license etc.) instead of the patient's registration card 103. By using these cards, the operations shown in FIG. 5 can be carried out.

Further, by further including ID data, or recording personal information in the card, the operations shown in FIGS. 6, 7 and 9 can be carried out.

Namely, the present system may be described as a system provided in a facility which keeps personal information with respect to plural individuals so as to allow the visitors regarding the personal information to view the personal information, which includes a data storing device for storing the personal information; and a data display device for displaying the personal information stored in the data storing device, wherein the data display device is a handy portable device.

Further, in the present embodiment, the central processing unit 2 controls the operations of the present system. However, the present invention is not limited to it, and it may be arranged such that the program for carrying out the operations of the present system or the display operation in the display terminal 1 is recorded on a recording medium, and an information processing device is provided for reading out the program, instead of providing the central processing unit 2 or the computing control section 124.

With this arrangement, a computing device (such as a CPU or a MPU) of the information processing device reads out the program recorded on the recording medium so as to carry out the operation. Namely, the program itself realizes the operation.

Here, the information processing device may be a common computer (work station or a personal computer), and in addition, it may be a feature expansion board or a feature expansion unit mounted to the computer.

Further, the program above is a program code (an execute form program, an intermediate code program, a source program, etc.) which realizes the operations of the present system or the display operation in the display terminal 1. The program may be the one works alone or the one works with other programs (such as OS). Further, the program may be the one read out from the recording medium, and is temporally stored in the memory (such as RAM) in the device, then is read out again so as to be carried out.

Further, the recording medium for recording the program may be the one can easily be removed from the information processing device, or may be the one fixed (mounted) to the device. Further, it may be an external storing apparatus, which is connected to the device.

As the recording medium, it may be selected from a magnetic tape such as a video tape or a cassette tape, a magnetic disk such as a floppy disk, or a hard disk, an optical disk (magneto-optical disk) such as a CD-ROM, an MO, an MD, a DVD, or a CD-R, a memory card an IC card, or an optical card, and a semiconductor memory such as a mask ROM, an EPROM, an EEPROM, or a flash ROM.

Further, the recording medium may be the one connected to the information processing device via a network (intranet, the Internet etc.). In this case, the information processing device obtains the program by downloading via the network. Namely, the information processing device may obtain the program via a transmission medium (a medium which dynamically holds the program) such as a network (through a wired line or a wireless line). Note that, it is preferable that the program for downloading is previously stored in the device.

Further, the medical information system of the present invention may be described as a medical information system provided in a medical institution for disclosing medical data to respective patients, including: a data storing device for storing the medical data; and a data display device for displaying the medical data stored in the data storing device, wherein the data display device includes: a display screen, a slot for inserting each patient's registration card of the patients, and a control section for reading out the medical data from the data storing device so as to display the medical data on the display screen, and the slot detects whether or not the patient's registration card is inserted therein; and the control section displays the medical data only when the patient's registration card is inserted in the slot.

Further, the medical information system of the present invention may be described as a medical information system provided in a medical institution for disclosing medical data to respective patients, including: a data storing device for storing the medical data; and a data display device for displaying the medical data stored in the data storing device, wherein the data display device includes: a slot for inserting each ID card having ID data which specifies the patient, and a control section for reading out the medical data from the data storing device so as to display the medical data on a display screen, and the slot reads out the ID data in the ID card inserted therein, and the control section reads out the medical data from the data storing device so as to display the medical data on the display screen, the medical data corresponding to the ID data thus read out by the slot.

Further, the medical information system of the present invention may be described as a medical information system provided in a medical institution for disclosing medical data to respective patients, including: a data storing device for storing the medical data; a data display device for displaying the medical data stored in the data storing device, a recording medium for recording the medical data of the patients; and a medium recording device for recording the medical data stored in the data storing device to the recording medium, wherein the data display device includes: a slot for reading out the medical data recorded on the recording medium, and a control section for displaying the medical data read out by the slot on a display screen.

Further, the medical information system of the present invention may be described as a medical information system provided in a medical institution for disclosing medical data to respective patients, including: a data storing device for storing the medical data and a data display device for displaying the medical data stored in the data storing device wherein the data display device is a portable mobile device, and the medical data includes plural types of data, and the data display device has an input section for accepting an input by a user, and the control section displays the plural types of medical data by switching the data in accordance with the user's instruction.

Further, the medical information display method of the present invention may be described as a medical information display method provided in a medical institution for disclosing medical data to respective patients, adopting a portable mobile data display device for displaying the medical data stored in a data storing device.

Further, the medical information display method of the present invention may be described as a medical information display method provided in a medical institution for disclosing medical data stored in a data storing device to respective patients by a data display device, including a process of detecting whether or not a patient's registration card of the patient is inserted in a slot of the data display device, and a process of reading out the medical data from the data storing device so as to display the medical data in the display screen of the data display device only when the patient's registration card is inserted in the slot.

A conventional computer network system has functions of data arrangement, data search, and data exchange etc. for efficiently using medical data in medical institutions. However, the conventional system uses a fixed display (using a CRT etc.), and this does not sufficiently provide the medical information of the patient when a doctor makes explanation to the patient.

More specifically, since the fixed display temporarily provides the medical data on the screen, it is not long enough for the patient to understand the information. Also, this does not give the patient assurance of looking at the results of examinations or diagnosis in his/her hands.

Further, when providing a handy display device to the patient, care should be taken by a hospital staff, as disclosure to a wrong patient may cause breach of the patient's privacy.

Further, the display terminal 1 is not required to have a data output function as long as it is capable of suitably displaying information inputted from the central processing unit 2. Further, the present system may have a function of obtaining medical image information or diagnosis record information stored in the central processing unit 2, or a function of writing or modifying with respect to the original data stored in the central processing unit 2 with the input terminal 3. Further, the present system is capable of reading information from the other medical institutions 6 with the input terminal 3, since the central processing unit 2 is connectable to the Internet 5 and therefore can obtain medical image information or diagnosis record information etc. in the other medical institutions 6.

Further, the present system may be arranged such that the input terminal 3 in the reception accepts the input of basic information of the patient such as the health insurance or the content of questioner so as to send the information to the central processing unit 2.

Further, by using the handy display terminal 1 of reflection-type, it allows the patient to view the display screen in a desired posture and easily understand the doctor's explanation, and also the doctor can make sure the condition of the patient shown in medical images such as X-ray picture, by reviewing the image with the patient.

Further, the information of the central processing unit 2 may be controlled by the data accepting control section 122 which transmits the state and information of the slot 102, and may be received by the data accepting device 123. Further, the received information may be stored in the storing device 125 and taken out by an order of the operation section 121 including the touch panel or the input buttons 104 so as to be displayed in the display screen 101 by the display control section 126 made of a driving circuit.

Further, FIG. 2 is an example of a pattern diagram of the display terminal 1 according to the present invention. Further, by using the display screen 101 adopting a display mode having memory function for the display terminal 1, the display screen 101 is capable of long hours display without running out of the buttery. Further, a reflection-type display consumes less power, and is capable of displaying an image like a picture painted on paper. Therefore, the patient more easily understands the medical data.

The present system is capable of displaying all medical data in the past of each patient on the display screen 101 of the display terminal 1. The medical data can be the details of treatments (diagnoses) and results of examinations and also includes the data from the other medical institutions 6, which is obtained via the Internet 5.

Further, a user may operate the input buttons 104 for switching or scrolling the display of the display screen 101; however, a touch tablet may be provided on the surface of the display screen 101 instead. This enables the user to operate the display terminal 1 by touching the screen with a finger or a touch-pen 105.

Further, the information of the patient such as diagnosis records, medical images, prescriptions, and explanations of medicines may be inputted to the display terminal 1 either directly from the central processing unit 2 or via the input terminal 3. However, at the input, it is preferable that the patient's registration card 103 is inserted in the slot 102. This patient's registration card 103 includes a simple circuit such as the one only having a conductive section.

The display terminal 1 may have a function of storing information and writing data which become available only when the patient's registration card 103 is inserted in the slot 102. When all desired information is provided to the patient with the display terminal 1 having various information, the patient's registration card 103 is removed from the slot 102. Here, it is preferable that all of the information of the patient in the display terminal 1 is deleted when the patient's registration card 103 is removed from the slot 102.

Further, FIG. 5 shows the flow of information display in the display terminal 1 (inputting and deleting operation of information to the display terminal 1). Further, the display terminal 1 may be used in the following manner. When the patient's registration card 103 is given to the reception by the patient upon arrival of the patient, a hospital worker (hospital staff) inserts the card to the slot 102 of an arbitrary display terminal 1 so as to writes the patient's information on the display terminal 1. Then, when the patient leaves the hospital, the patient's registration card 103 is taken out from the slot 102 by the patient to be taken away with the patient. In this manner, it is possible to prevent disclosing the patient's information to a wrong patient due to such as an operational mistake by a hospital worker. Further, the patient can delete the medical data from the display terminal 1 by his/her own operation, and therefore, the patient feels secure about privacy protection.

Further, the information of the patient such as diagnosis records, medical images, prescriptions, and explanations of medicines may be inputted to the display terminal 1 either directly from the central processing unit 2 or via the input terminal 3. However, at the input, it is preferable that the patient's registration card 103 made of an IC card is inserted in the slot 102. The IC card has a simple structure and at least stores a number (ID data) for specifying the patient. In this case, the central processing unit 2 carries out data writing on the display terminal 1 when confirming that the owner of the card coincides with the patient corresponding the information.

As to another possible example, the owner's data (ID data) of the patient's registration card 103 may be sent to the central processing unit 2 when the communication between the display terminal 1 and the central processing unit 2 becomes ready, and the central processing unit 2 may send back the information of the patient (the owner of the patient's registration card 103) to the display terminal 1.

Further, FIG. 6 shows the flow of information display in the display terminal 1 in the case above. Further, In the operations shown in FIGS. 6, 7 and 8, the central processing unit 2 carries out data writing on the display terminal 1 when confirming that the owner of the card coincides with the patient corresponding to the information. Also, the information of the patient (the owner of the patient's registration card 103) is automatically written to the display terminal 1 from the central processing unit 2, and it prevents information disclosure to a wrong patient. Further, this manner does not allow the patient to unwittingly view the medical data of the wrong patient.

Further, Any types of patient's registration card 103 may be used in the operations shown in FIGS. 6 and 7 as long as it can specify the owner. Further, an IC card having the patient's information may off course be used for the patient's registration card 103 to obtain the same effect.

Further, when using the patient's registration card 103 having recording function for medical data, the medical data stored in the central processing unit 2 may be inputted to the patient's registration card 103 by a hospital staff (medical staff) using the input terminal 3, for example. Further, after the patient's registration card 103 having the medical information is inserted in the display terminal 1, and the medical information is sufficiently provided to the patient, the patient's registration card 103 is taken out from the slot 102 by the patient. Here, when the patient's registration card 103 is not inserted in the slot 102, the display terminal 1 loses the storing medium of the medical data, i.e., there is no medical data exist in the display terminal 1.

Further, the present invention may be described as five types of medical system as follows.

The first medical system is a medical information system in a medical institution which includes an input terminal, a display terminal and a central processing unit. The system is capable of inputting each patient's medical information from the input terminal, storing the information in the central processing unit, and displaying the individual medical information in the display terminal.

Further, the second medical system has a function such that the central processing unit 2 obtains the individual medical information from other medical institutions via the Internet.

Further, the third medical system has a function such that the display device displays all medical information with respect to each patient, and displays desired medical information by switching various kinds of medical data.

Further, the fourth medical system has a function such that the display terminal writes the individual medical information on the patient's registration card having an electronic circuit by inserting the card in the display terminal, and deletes all information from the patient's registration card by taking out the card.

Further, the fifth medical system has a function such that the individual medical information is inputted from one of the input terminal, and transferred to the central processing unit 2, and further transferred to the other input terminals.

As described, the medical information system of the present invention (the present system) is a medical information system provided in a medical institution for disclosing medical data to respective patients, including a data storing device for storing the medical data; and a data display device for displaying the medical data stored in the data storing device, and the data display device is a portable mobile device.

A noticeable feature of the present invention is that the data display device is a portable mobile device. Namely, the patient can have the data display device in his/her hand (or by an attendant, a staff in the medical institution), and can set the display device (display screen) in an arbitrary angle. With this type of display, the patient can view the display screen in a desired posture and also it allows a disabled person can easily view the content of display.

Therefore, it is possible to sufficiently protect privacy of the patients since medical data is disclosed only to the patient corresponding to the medical data, thereby providing a barrier-free medical information system.

Namely, by using such a data display device, the patient can see the data in any arbitrary places as long as he/she wants without being seen by other people, for example, in a corridor where no one else is around, or having a wall or a window behind, or in the corner of the waiting room.

Further, it is preferable that the data display device includes a control section for reading out the medical data from the data storing device so as to display the medical data on the display screen. Also a storing device may be provided in the data display device so as to temporarily store the read out medical data.

With this structure, it is preferable that the data display device includes a slot for inserting each patient's registration card of the patients, and the slot detects whether or not the patient's registration card is inserted therein. Further, it is preferable that the control section displays the medical data only when the patient's registration card is inserted in the slot.

In this structure, the slot and the patient's registration card work as a switch for displaying the medical data in the data display device. Namely, it allows the patient to display the medical data in the data display device by inserting the patient's registration card, and also, to cancel the display by removing the patient's registration card.

Here, the patient's registration card 103 is always taken away with the patent when the patient leaves the hospital. Accordingly, after referring to the medical data, the patient can confirm the end of the medical data display with an operation by himself/herself (taking out (away) the patient's registration card 103).

Therefore, the patient feels secure about privacy protection, as there is no possibility that the medical data is still left in the display terminal 1 which has been used once the patient takes out the patient's registration card. Note that, when a storing device for storing the medical data is provided in the data display device, it is preferable that the control section deletes all of the medical data in the storing device when the patient's registration card is removed from the slot.

Further, in the present system, it is preferable that all the patients in the medical institution have particular ID data (information for specifying the patient; a serial number or the like). In this structure, it is preferable that the data display device includes an input section for accepting an input by a user. Also, it is preferable that when ID data which specifies the patient is inputted into the input section, the control section reads out the medical data from the data storing device in accordance with the ID data thus inputted, and displays the medical data on the display screen.

The foregoing structure makes it easier to selectively display the medical data corresponding to the viewer (the medical data supposed to be displayed). Further, using the ID card above having ID data makes it possible to selectively display the medical data corresponding to the viewer. In this structure, it is preferable that the data display device includes a slot for inserting the ID card having the ID data, and a control section.

Further, it is preferable that the slot reads out the ID data in the inserted ID card, and the control section reads out the medical data from the data storing device in accordance with the ID data thus read out by the slot, and displays the medical data on the display screen. In this manner, the control section obtains the medical data according to the ID data read out by the slot. Therefore, it is possible to prevent disclosure of wrong medical data (the medical data of a wrong patient) to the patient by error operation (inputting a wrong ID data) etc. Further, since it is not necessary to manually input the ID data, the display operation can be carried out more quickly and easily.

Further, in this structure, it is preferable that the control section displays the medical data only when the ID card is inserted in the slot. This allows a user to easily finish the medical data display by taking out the ID card from the slot.

Further, the patient's registration card may be used for the ID card above by including the ID data therein. By thus using the patient's registration card, the patient is not likely to unintentionally leave the card in the slot after the display.

Further, in the structure using the ID card, the data display device may include an input section for accepting an input by a user, and only when the ID data inputted to the input section coincides with the ID data read out by the slot, the control section reads out the medical data corresponding to the ID data from the data storing device so as to display the medical data on the display screen.

In this structure the control section check the ID data inputted to the input section with the ID data read out by the slot, and when the two ID data coincide with each other, the control section displays the medical data. Therefore, it is possible to prevent disclosure of wrong medical data (the medical data of a wrong patient) to the patient by error operation (inserting a wrong ID card) etc.

Further, in the foregoing structure, the data display device directly obtains the medical data from the data storing device. However, the present invention is not limited to it, and the medical data may be transmitted to a recording medium, and further transmitted to the data display device.

Namely, the present system may include a recording medium for recording the medical data of the patients; and a medium recording device for recording the medical data stored in the data storing device to the recording medium.

In this case, it is preferable that the data display device includes a slot for reading out the medical data recorded on the recording medium, and a control section for displaying the medical data read out by the slot on a display screen.

The foregoing arrangement allows the patient to carry he recording medium having the medical data. Therefore, the patient can display the medical data in the data display device without communicating with the data storing device.

Further, the patient can view the medical data anytime he/she wants and anywhere (for example, at home, or at the working place) as long as the patient can carry out the display of the recording medium.

Further, the patient's registration card may be used for the recording medium above by having a data recording function. By thus using the patient's registration card, the patient is not likely to unintentionally leave the recording medium in the hospital.

Further, it is preferable that the present system includes a data obtaining device for obtaining medical data from other medical institutions via an Internet so as to store the medical data in the data storing device. With this function, the patient can view medical data from other medical institution by using the data display device.

Further, it is preferable that the present system includes a data modifying device for modifying the medical data stored in the data storing device, or a data registration device for storing (registering) new medical data regarding a new patient in the data storing device. Further, as with the embodiment above, it is preferable that the display screen is made of a reflection-type display panel having memory function.

Here, the display screen 101 of the display terminal 1 displays the medical data of a patient. The medical data is generally displayed as a still picture in the display screen 101 and a user can view the data for a desired time. Therefore, by using a display panel having memory function which can reduce refresh frequency of the display, it is possible to reduce power consumption. A reflection-type display panel having memory function is capable of long hours display without running out of the buttery. Further, a reflection-type display consumes less power, and is capable of displaying an image like a picture painted on paper. Therefore, the patient more easily understands the medical data.

Further, as with the embodiment above, when the display terminal 1 (data display device) includes a storing device 125 for storing the medical data, it is preferable that the computing control section 124 deletes all of the medical data in the storing device 125 when the patient's registration card 103 is removed from the slot.

By thus using the patient's registration card, the patient is not likely to unintentionally leave the card in the slot after the display. Therefore, there is no possibility that the medical data is still left in the display terminal 1 which has been used once the user takes out the patient's registration card. Thus, the user feels secure about privacy protection.

Further, in the embodiment above, a user operates the input section such as the input buttons 104 or a touch pen 105 for scrolling the display or changing the display content of the display screen 101 of the display terminal 1 (data display device); however, the present invention is not limited to it.

Namely, the data display device of the medical information system may add memo data inputted from the input section to the medical data stored in the data storing device.

For example, user inputs memo data such as a note or questions for the medical data displayed in the display screen 101 which has been read out from the central processing unit 2 (data storing device), by using the input section such as the input buttons 104 or a touch pen 105. Then, the display terminal 1 add the inputted memo data to the displayed medical data. The memo data is stored in the central processing unit 2 with the medical data.

This structure allows the user to easily confirm the progress of the cure with reference to the memo data. Further, it allows the doctor to recognize the patient's concern, and clear away the concern by making more precise explanation, thereby providing a user friendly medical information system.

Further, as with the embodiment above, it is preferable that the display terminal 1 (the data display device of the present invention) displays the medical data stored in the central processing unit 2 (data storing device), and also the display terminal 1 is a portable mobile device.

Also in this structure, the patient can view the mobile display device in a desired posture. Therefore, it is possible to disclose the medical data only to the patient corresponding to the medical data. Further, this allows a disabled person to easily view the content of display. Thus, it is possible to sufficiently protect privacy of the patients since medical data is disclosed only to the corresponding patient, thereby providing a barrier-free medical information system.

Further, in the embodiment above, the central processing device 2 transmits the medical data to the display terminal 1, which is a wireless terminal device. Here, this medical data transmission by the central processing device 2 may be carried out using e-mail via a wireless communication line. Namely, the central processing device 2 may be described as a medical information transmission device, including a data storing device for storing the medical data, and transmits the medical data to a portable mobile device of each patient using e-mail via a wireless communication line.

With the foregoing structure, the display terminal 1 can be realized by using mobile phones, or PDA (Personal Digital Assistants), which are mobile information terminals capable of receiving e-mails via a wireless communication line. By thus using these widely used terminals, it is possible to realize the medical information system of the present invention with a combination of the display terminal 1 and the central processing unit 2 (medical information transmission device) easily and with low cost.

Note that, in the foregoing explanation, the patient obtains the display terminal 1 upon arrival at the hospital, and gives the terminal back when he/she leaves; however, the present invention is not limited to it.

For example, the patient may bring the display terminal 1 to the hospital, and obtains the patient's registration card 103 upon arrival at the hospital and gives back the patient's registration card 103 when he/she leaves. Also in this manner, the medical information system of the present invention can easily be realized by using the display terminal of a PDA and the patient's registration card 103 of an IC card, for example.

The present invention is not limited to the described examples, and may be varied in many ways within the scope of claims. Namely, embodiments by using an appropriate combination of the technical means disclosed in the various examples above are also included in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A medical information system provided in a medical institution for disclosing medical data to respective patients, comprising:
a data storing device for storing the medical data; and
a data display device for displaying the medical data stored in the data storing device,
the data display device being a portable mobile device.

2. The medical information system as set forth in claim 1, wherein the data display device includes:
a display screen;
a slot for inserting each patient's registration card of the patients; and
a control section for reading out the medical data from the data storing device so as to display the medical data on the display screen,
the slot detects whether or not the patient's registration card is inserted therein; and
the control section displays the medical data only when the patient's registration card is inserted in the slot.

3. The medical information system as set forth in claim 2, wherein the data display device includes:
an input section for accepting an input by a user, and when ID data which specifies the patient is inputted into the input section, the control section reads out the medical data from the data storing device in accordance with the ID data thus inputted, and displays the medical data on the display screen.

4. The medical information system as set forth in claim 1, wherein the data display device includes:
a slot for inserting each ID card having ID data which specifies the patient; and
a control section for reading out the medical data from the data storing device so as to display the medical data on a display screen,
the slot reads out the ID data in the ID card inserted therein; and
the control section reads out the medical data from the data storing device so as to display the medical data on the display screen, the medical data corresponding to the ID data thus read out by the slot.

5. The medical information system as set forth in claim 4, wherein:
the control section displays the medical data only when the ID card is inserted in the slot.

6. The medical information system as set forth in claim 4, wherein the data display device includes:
an input section for accepting an input by a user, and only when the ID data inputted to the input section coincides with the ID data read out by the slot, the control section reads out the medical data corresponding to the ID data from the data storing device so as to display the medical data on the display screen.

7. The medical information system as set forth in claim 1, further comprising:
a recording medium for recording the medical data of the patients; and
a medium recording device for recording the medical data stored in the data storing device to the recording medium,
the data display device including:
a slot for reading out the medical data recorded on the recording medium; and
a control section for displaying the medical data read out by the slot on a display screen.

8. The medical information system as set forth in claim 1, further comprising:
a data obtaining device for obtaining medical data from other medical institutions via an Internet so as to store the medical data in the data storing device.

9. The medical information system as set forth in claim 2, wherein:
the display screen is made of a reflection-type display panel having memory function.

10. The medical information system as set forth in claim 2, wherein the data display device includes:
a storing device for storing the medical data read out from the data storing device, and
the control section deletes all of the medical data in the storing device when the patient's registration card is removed from the slot.

11. The medical information system as set forth in claim 4, wherein the data display device includes:
a storing device for storing the medical data read out from the data storing device, and
the control section deletes all of the medical data in the storing device when the patient's registration card is removed from the slot.

12. The medical information system as set forth in claim 3, wherein:
the data display device adds memo data inputted from the input section to the medical data stored in the data storing device.

13. The medical information system as set forth in claim 6, wherein:
the data display device adds memo data inputted from the input section to the medical data stored in the data storing device.

14. A data display device, wherein:
medical data stored in a data storing device is displayed, and the data display device is a portable mobile device.

15. A medical information transmission device, comprising:
a data storing device for storing the medical data, the medical information transmission device transmitting medical data to a portable mobile device of each patient using e-mail via a wireless communication line.
